(19) United States
(12) Patent Application Publication
(10) Pub. No.: US 2021/0169056 A1
(43) Pub. Date: Jun. 10, 2021

(54) AQUATIC TRAP

(71) Applicant: Erick Bendure, Bellingham, WA (US)

(72) Inventor: Erick Bendure, Bellingham, WA (US)

(21) Appl. No.: 17/179,780

(22) Filed: Feb. 19, 2021

Related U.S. Application Data
(63) Continuation-in-part of application No. PCT/US19/46381, filed on Aug. 13, 2019.
(60) Provisional application No. 62/719,822, filed on Aug. 20, 2018.
(60) Provisional application No. 63/039,029, filed on Jun. 15, 2020.

(51) Int. Cl. A01K 69/08; A01K 69/10

(52) U.S. Cl. CPC A01K 69/08; A01K 69/10

(57) ABSTRACT

Aquatic traps disclosed herein can be used for trapping crustaceans such as crab, prawns and shrimp, as well as fish and including flat fish. The traps can include a trap frame surrounded by mesh. The trap frame can include a tapered side which allows nested stacking of traps. The mesh can include floor mesh, side mesh, entrance mesh, and ceiling mesh. The entrance mesh can extend inwardly from a portion of the tapered side, and attach to an entrance frame. A tensioning element may hold the entrance frame upright inside the trap, or otherwise, the entrance frame can be self-erecting. The ceiling mesh can be releasable to collapse the ceiling and the entrances, thereby facilitating nested stacking of the traps.

### CROSS-REFERENCE TO RELATED APPLICATIONS

This is a continuation-in-part claiming priority of Patent Cooperation Treaty Application Number PCT/US19/46381, filed Aug. 13, 2019, entitled “CRUSTACEAN TRAP,” which claims priority of U.S. Provisional Application No. 62/719,822, entitled “CRAB POT,” filed Aug. 20, 2018. This is also a non-provisional claiming priority to U.S. Provisional Application No. 63/039,029, entitled “AQUATIC TRAP,” filed Jun. 15, 2020. The prior applications are incorporated by reference herein.

### BACKGROUND

Aquatic traps, such as crab, prawn, and shrimp traps, are devices which are dropped off of fishing boats to the sea floor in order to catch crustaceans and fish. A variety of aquatic trap designs have been developed.

The basic elements of a crab trap, also referred to as a crab pot, generally include a cage with hinged doors that open inward only. Bait is fastened inside the cage. Crabs push the doors open to enter the cage, and the crabs become trapped inside when they are subsequently unable to push the doors outward. A long line is attached at the top of the cage, and a buoy is tied to an opposite end of the line. The buoy floats at the water's surface while the crab pot is left on the sea floor for a period of time. Prawn and shrimp traps are similar to crab traps, in that they are generally configured as cages that sink to the sea floor, and which have entrances that are more easily entered than exited.

Fishermen generally load multiple crab or prawn/shrimp traps on a boat, sail to their fishing grounds, bait the traps, and drop them overboard in various locations. The fishermen may then return to shore to retrieve additional traps as desired, repeating the operation as needed to deploy the desired number of traps. They then return to the traps, pull them back to the surface, and retrieve any crustaceans trapped inside. They may again make several trips as needed to return the traps to shore or to the next fishing grounds.

Fishing is labor intensive, and there is a need in the industry for improved trap designs which can improve the efficiency and effectiveness of fishing operations.

### SUMMARY

This disclosure presents improved aquatic traps along with methods of manufacturing and using the improved traps. In some examples, an improved aquatic trap may comprise a trap frame. The trap frame can include a floor frame section and a ceiling frame section. The surface area of the ceiling frame section can be larger than the surface area of the floor frame section. A plurality of angled struts can connect the floor frame section to the ceiling frame section. The angled struts define a tapered or angled side between the floor frame section and the ceiling frame section.

The trap frame may be surrounded with mesh, including a floor mesh extending over the floor surface area, a side mesh extending over portions of the tapered side, and a ceiling mesh extending over the ceiling surface area. One or more entrances through the tapered side can comprise an entrance mesh extending inwardly from a portion of the tapered side to an entrance frame. The entrance frame can be movable with respect to the trap frame, and in some embodiments, the entrance frame can be a self-erecting entrance frame which lies flat when the trap is stacked, and which self-erects into a vertical orientation when the trap is unstacked, as described further herein.

The disclosed aquatic traps can allow nested stacking of multiple aquatic traps. First, the tapered sides of the traps allow nested stacking of traps. Second, the ceiling mesh can be releasable to allow nested stacking of multiple traps, and the ceiling mesh can be restorable for trap deployment. Third, entrance frames can also be movable or collapsible to facilitate nested stacking. For traps without self-erecting entrance frames, a tensioning element can pull the entrance frames inwardly to hold the entrance frames in place for fishing. The tensioning element can be released to allow the entrance frames to rotate, collapse or otherwise or move aside for nested stacking.

The disclosed traps can furthermore include features for adjusting trap weight. In an example embodiment, a weight bar can be affixed to the trap frame, and the weight bar can include attachment points for removable weighting elements. Further aspects of the invention are described in detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 illustrates an example trap frame along with entrance frames, a tensioning element and a weight bar.

FIG. 2 provides another view of the example trap frame introduced in FIG. 1.

FIG. 3 illustrates the example trap frame introduced in FIG. 1, along with example entrance meshes installed at entrances thereof.

FIG. 4 illustrates the example trap frame introduced in FIG. 1, along with example side and floor mesh installed thereon.

FIG. 5 illustrates an example first complete trap.

FIG. 6 illustrates an example second complete trap.

FIG. 7 illustrates nested stacking of multiple traps.

FIG. 8 illustrates an example prawn and shrimp trap.

FIG. 9 illustrates an elevation view of the example prawn and shrimp trap introduced in FIG. 8.

FIG. 10 illustrates the example prawn and shrimp trap introduced in FIG. 8, and further comprising a collapsible ceiling mesh.

FIG. 11 illustrates an example self-erecting entrance frame, as well as a wide aspect ratio entrance frame.

FIG. 12 provides a front elevation view of another example self-erecting entrance frame.

FIG. 13 provides a side elevation view of the example self-erecting entrance frame introduced in FIG. 12.

FIG. 14 provides a side elevation view of an aquatic trap frame comprising a self-erecting entrance frame that uses the biasing mechanisms introduced in FIG. 11 and FIG. 12.

FIG. 15 illustrates an example aquatic trap frame comprising a weight adjustment system.

### DETAILED DESCRIPTION

Prior to explaining embodiments of the invention in detail, it is to be understood that this disclosure is not limited to the details of construction or arrangements of the components and method steps set forth in the following description or illustrated in the drawings. Embodiments of this disclosure are capable of other embodiments and of being practiced and carried out in various ways. Also, it is to be understood that the phraseology and terminology employed herein are for the purpose of the description and should not be regarded as limiting.

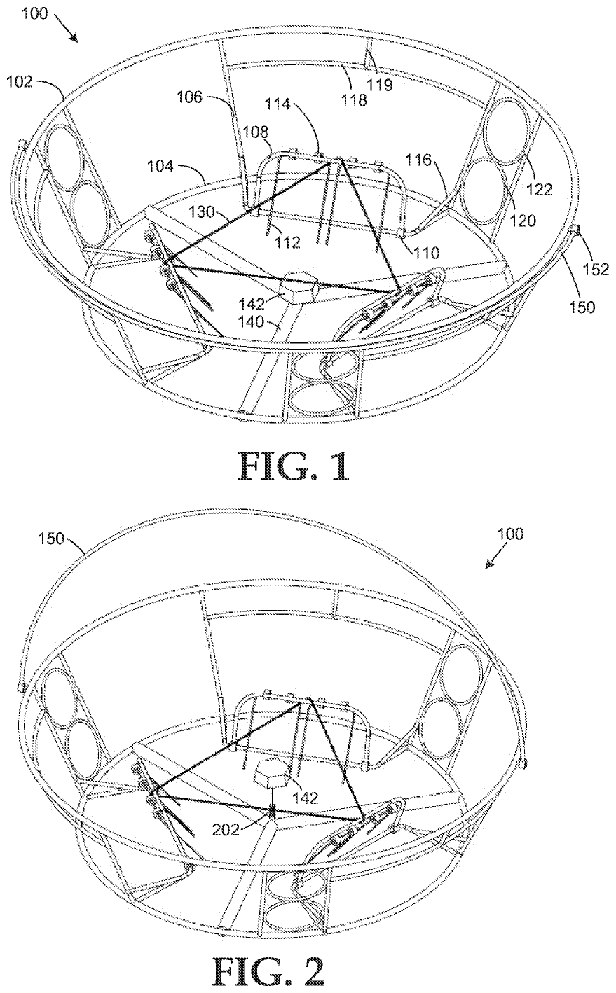

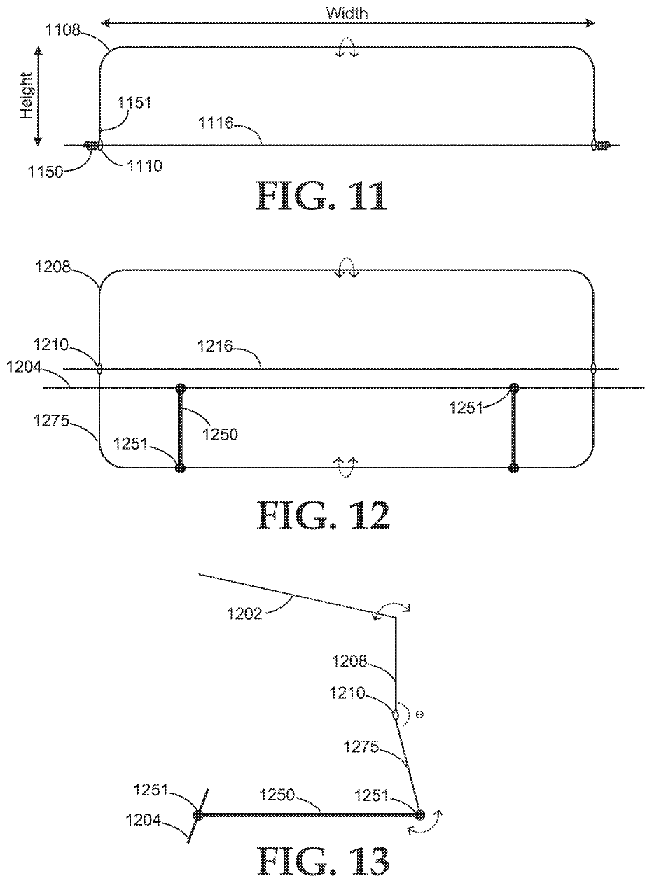

Embodiments according to FIGS. 1-6 can optionally be used to catch crab, and so may be referred to herein as a crab trap. Embodiments according to FIGS. 8-10 can optionally be used to catch prawn and shrimp, and so may be referred to herein as a prawn and shrimp trap. Embodiments according to FIGS. 1-6 which incorporate wide aspect ratio entrance frames, illustrated in FIGS. 11 and 12, in place of the entrance frames illustrated in FIGS. 1-6, can optionally be used to catch flat fish, and so may be referred to herein as flat fish traps. However, it will be appreciated that all of the disclosed traps incorporate many similar elements, and any trap can be used as desired to attempt to catch any desired crustacean or fish.

FIG. 1 illustrates an example trap frame, and FIG. 1 further illustrates entrance frames, a tensioning element and a weight bar, in accordance with various aspects and embodiments of the subject disclosure. The trap frame 100 may be made, e.g., of stainless steel, rubber coated mild steel, Polly Vinyl Chloride (PVC) coated steel, or other suitably rigid and corrosion resistant material. In some embodiments, a trap frame 100 can be made of composite material, optionally through a 3D printing process. The trap frame 100 includes a floor frame section 104 defining a floor surface area. The term “surface area” as used herein does not necessarily imply the presence of a surface, but can be simply the area defined by the surrounding element. In the illustrated embodiment, the floor frame section 104 includes a circular ring at the bottom of the trap frame 100. The trap frame 100 further includes a ceiling frame section 102 defining a ceiling surface area which is larger than the floor surface area. In the illustrated embodiment, the ceiling frame section 102 includes a circular ring at the top of the trap frame 100.

The trap frame 100 further includes a plurality of angled struts, such as example angled strut 106 and example angled strut 122, which connect the floor frame section 104 to the ceiling frame section 102 and define a tapered side between the floor frame section 104 and the ceiling frame section 102. In the illustrated embodiment, there are nine (9) angled struts, although more or fewer angled struts may be appropriate for other embodiments. The tapered side between the floor frame section 104 and the ceiling frame section 102 comprises an outer “surface” of the conical shape defined by the trap frame 100—although again, there is not necessarily any actual material surface, as will be understood from FIG. 1. In some embodiments, an angle at which the angled struts 106, 122 connect to the floor frame section 104 and the ceiling frame section 102 can comprise, e.g., a ten to twenty degree angle, for example, a fifteen degree angle, as measured from vectors extending normal (perpendicular) from the floor surface area or ceiling surface area, respectively.

Circular “escape rings” 120 can be attached between some of the angled struts. By Washington State law, crab traps must have at least two escape rings of four and one quarter (4.25) inches in size, located in the top half of the crab trap. Other jurisdictions may have other escape mechanism requirements and the trap frame 100 can be modified to comply with the applicable requirements. As an optional additional feature, crossbars 118 can extend between angled struts, as shown, to form escape windows for undersize crabs. The escape windows can be over the entrances to the trap, as shown. Vertical elements 119 can optionally divide escape windows into multiple sections as desired.

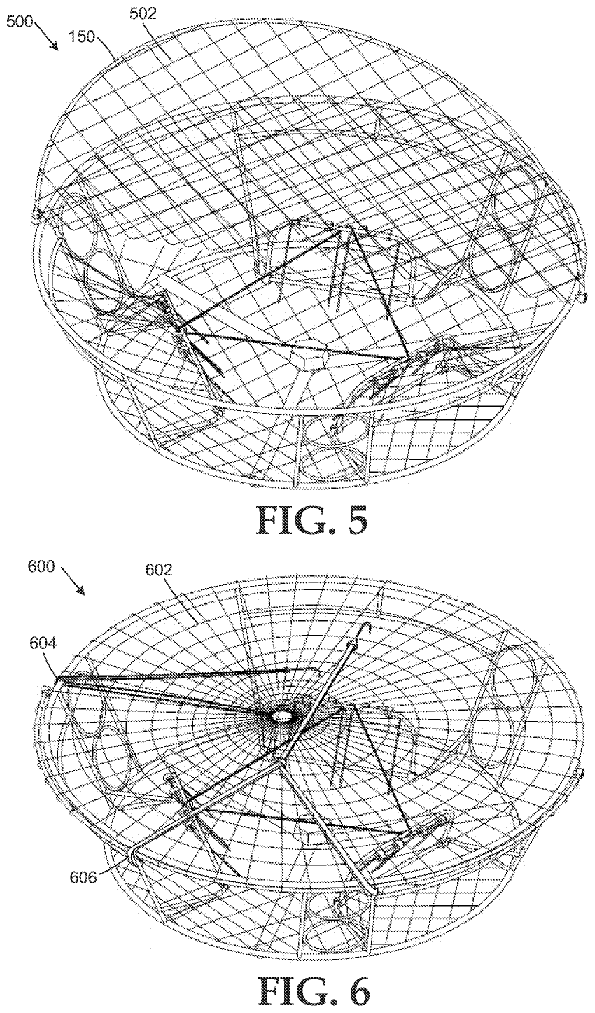

A lid 150 can be attached to the trap frame 100, e.g., by hinge elements 152. The lid 150 can be semicircular and openable and closable to access an interior of the trap without releasing a ceiling mesh, e.g., as illustrated in FIG. 5. The releasable ceiling mesh is discussed further in connection with FIG. 6.

Entrance frames 108 can also optionally be attached to the trap frame 100. In the illustrated embodiment, entrance frames 108 are attached by entrance frame hinge elements 110 to support struts 116, and support struts 116 are welded to the trap frame 100. Support struts 116 can include elements extending inwardly from the trap frame 100 into the crustacean trap, as shown. Support struts 116 can optionally be braced to the angled struts 106 for better vertical strength, as shown. Support struts 116 can include crossbar elements that support the hinge elements 110, as shown. Entrance frames 108 can rotate forward and backward on the support struts 116, thereby allowing entrance frames 108 to rotate up for fishing, and down for nested stacking of traps. In another example embodiment, entrance frames 108 need not be attached to the trap frame 100, for example as illustrated in FIG. 8.

In some embodiments the entrance frames 108 can comprise wide aspect ratio frames, with a relatively large width dimension and a relatively short height dimension, e.g., as illustrated in FIG. 11 and FIG. 12. Furthermore, regardless of aspect ratio, the entrance frames 108 can optionally comprise self-erecting entrance frames, e.g., as illustrated in FIG. 11, FIG. 12, and FIG. 13. Self-erecting entrance frames need not necessarily employ a tensioning element 130.

In the illustrated embodiment, one-way gates 112 are attached by gate hinges 114 to the entrance frames 108. The illustrated one-way gates 112 can comprise “U” shaped metal elements with arms that extend downwardly below the crossbar elements of support struts 116, so that the one-way gates 112 can swing inwardly into the trap, but cannot swing outwardly.

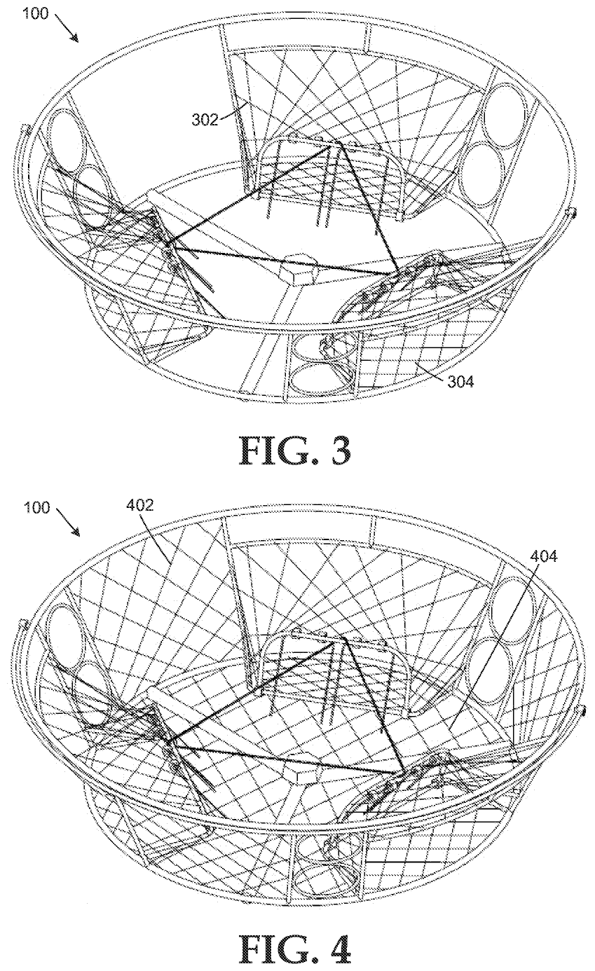

FIG. 1 furthermore illustrates a tensioning element 130. The tensioning element 130 can comprise, e.g., a wire, a line, a twine, a cord fitted with a coil spring, or an elastic element such as a bungee cord, secured to the entrance frames 108, in order to pull the entrance frames 108 inwardly. The tension applied by tensioning element 130 is countered by tension applied in an opposite direction by entrance mesh, as shown for example in FIG. 3. The entrance frames 108 can be held upright by the tensioning element 130 and the entrance mesh.

The tensioning element 130 can be releasable to allow the entrance frames 108 to collapse by rotating on the entrance frame hinge elements 110, to facilitate nested stacking of multiple traps. Bait may be conveniently zip-tied or otherwise attached to the tensioning element 130.

In some embodiments, springs or other biasing mechanisms may be used to bias the entrance frames 108 into either a vertical (restored) or horizontal (collapsed) position. For self-erecting entrance frames, such as illustrated in FIG. 11 and FIG. 12, entrance frames can be biased into a vertical (restored) position, and entrance frames can be held upright by the biasing mechanism and the entrance mesh. When traps are stacked, self-erecting entrance frames can be forced to collapse into a horizontal (collapsed) position by the weight of a trap stacked above which overcomes the biasing mechanism. The self-erecting entrance frames therefore rotate on the entrance frame hinge elements 110, to facilitate nested stacking of multiple traps. Bait may be conveniently attached anywhere within the aquatic trap 100.

In the embodiment illustrated in FIG. 1, the tensioning element 130 is shared by the three entrance frames 108 by extending between the entrance frames 108. Alternatively, multiple tensioning elements 130 could be used, e.g., one tensioning element 130 for each of entrance frames 108. Furthermore, in the illustrated embodiment, the tensioning element 130 forms a full triangle. In some embodiments, tensioning element 130 need not complete the circuit, for example, it may include just two legs of the triangle and remain similarly functional. In some embodiments, tensioning element 130 can include a hook or other fastener to fasten and release tensioning element 130 from the entrance frames 108. Alternatively, tensioning element 130 can comprise an elastic material to allow entrance frames 108 to rotate outwardly towards the sides of the trap.

FIG. 1 also illustrates a weight bar 140 attached to the floor frame section 104. In the illustrated embodiment, the weight bar 140 is a thicker gauge than the trap frame 100, and the weight bar 140 is configured in a “Y” shape consisting of three members joined at a middle of the floor surface area. The weight bar 140 is attached to the floor frame section 104 at a perimeter of the floor surface area. Weight bar 140 members may have threaded posts affixed thereto and extending upwardly therefrom, or, conversely, threaded holes into which threaded posts can be screwed, or other fasteners such as magnets, snaps, clips, ties, slots or the like. In the embodiment illustrated in FIG. 1, the threaded posts are designed to fit an anode 142 made of zinc or aluminum. The purpose of this anode 142 is to minimize electrolysis created by positively charged salt water moving through the trap while grounded to the sea floor, thereby preventing corrosion of the trap frame 100.

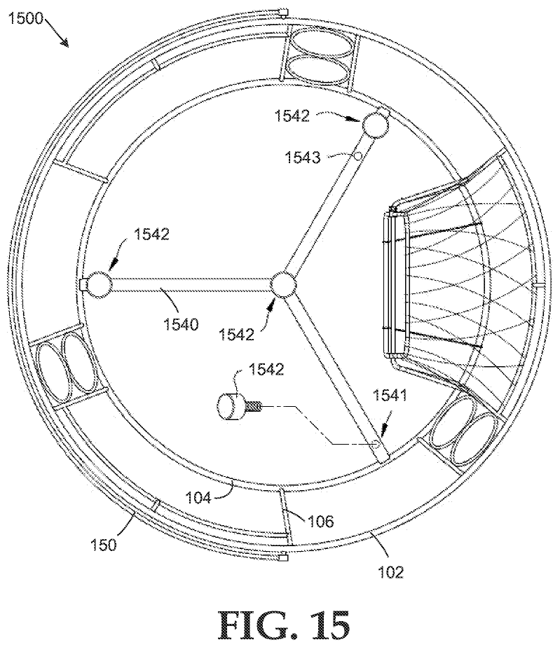

In some embodiments, such as illustrated in FIG. 15, a weight bar can optionally be made of a relatively lightweight material, and the weight bar members may comprise fasteners such as threaded posts or the like, described above, for the purpose of attaching weights to the weight bar, thereby permitting adjustment of the trap weight. It can be desirable to adjust the weight of the traps for a variety of reasons, e.g., for different expected current strength, or to allow for lightweight storage and transport of the traps.

FIG. 1 illustrates multiple entrance frames 108 which can attach to multiple entrance meshes, as illustrated in FIG. 3, to form multiple entrances into the trap. While FIG. 1 illustrates three entrance frames 108, it will be appreciated that any number of entrance frames 108 can be included, for example, the trap can consist of three, six, nine, or twelve entrance frames 108 in various alternative embodiments.

FIG. 2 provides another view of the example trap frame 100 introduced in FIG. 1, in accordance with various aspects and embodiments of the subject disclosure. Repetitive description of like elements is omitted for the sake of brevity. FIG. 2 illustrates an open lid 150 and a threaded post 202 extending from the weight bar 140. The anode 142 can comprise a threaded hole to screw and unscrew the anode 142 on the threaded post 202. While the example threaded post 202 extends from the middle of the weight bar 140, the threaded post 202 can be positioned anywhere on weight bar 140. Furthermore, embodiments can include multiple threaded posts 202 for multiple anodes 142, or for attachment of weights as described in connection with FIG. 15. The threaded post 202 is one example fastener to fasten an anode 140 to the trap, other fasteners may be used in other embodiments.

FIG. 3 illustrates the example trap frame 100 introduced in FIG. 1, along with example entrance meshes installed at entrances thereof, in accordance with various aspects and embodiments of the subject disclosure. Repetitive description of like elements is omitted for the sake of brevity. The illustrated entrance meshes each comprise an upper mesh 302 having relatively larger mesh openings, and a lower mesh 304 having relatively smaller mesh openings. The smaller openings of the lower mesh 304, e.g., a one and a half (1.5) inch mesh, can facilitate travel over lower mesh 304, e.g., by crabs. The larger openings of the upper mesh 302, e.g., a four (4) inch mesh, can comprise a same mesh as used for the floor mesh, ceiling mesh, and side mesh.

The illustrated entrance meshes extend inwardly from respective portions of the tapered side of the trap frame 100. Inward ends of the respective entrance meshes are attached to respective entrance frames 108 as well as the crossbar elements of respective support struts 116. Outward ends of the respective entrance meshes attach to respective portions of the trap frame 100. FIG. 3 illustrates how the tensioning element 130 can be countered by tension in the entrance meshes in order to hold the entrance frames 108 upright. Release of the tensioning element 130 can allow the entrance frames 108 to rotate outward toward the tapered side of the trap frame 100.

FIG. 4 illustrates the example trap frame 100 introduced in FIG. 1, along with example side and floor mesh installed thereon, in accordance with various aspects and embodiments of the subject disclosure. Repetitive description of like elements is omitted for the sake of brevity. FIG. 4 includes a floor mesh 404 extending over the floor surface area of the trap frame 100, and a side mesh 402 extending over a first portion of the tapered side, wherein additional side mesh panels extend over additional portions of the tapered side. In FIG. 4, side mesh 402 extends over a first portion of the tapered side, and a second portion of the tapered side, immediately to the right of side mesh 402, is used for an entrance mesh extending inwardly from the second portion of the tapered side. Additional portions of the tapered side are used for additional side mesh panels and additional entrances.

FIG. 5 illustrates an example first complete trap in accordance with various aspects and embodiments of the subject disclosure. Repetitive description of like elements is omitted for the sake of brevity. First complete trap 500 includes the trap frame 100 introduced in FIG. 1, along with the other elements from FIGS. 1-4 and a first example ceiling mesh 502 installed thereon. In FIG. 5, the ceiling mesh 502 comprises a web of flexible cord extending between the lid 150 and a back portion of the ceiling frame section 102. When the lid 150 is closed, the ceiling mesh 502 extends over the entire ceiling surface area. When the lid 150 is open, the ceiling mesh 502 extends over half of the ceiling surface area, allowing for easy access to the interior of the crab trap.

FIG. 6 illustrates an example second complete trap in accordance with various aspects and embodiments of the subject disclosure. Repetitive description of like elements is omitted for the sake of brevity. Second complete trap 600 includes the trap frame introduced in FIG. 1, along with the other elements from FIGS. 1-4 and a second example ceiling mesh 602 installed thereon. Like the ceiling mesh 502, the ceiling mesh 602 comprises a web of flexible cord extending between the lid 150 and a back portion of the ceiling frame section 102. The ceiling mesh 602 is furthermore releasable to allow nested stacking of multiple traps, and the ceiling mesh 602 is restorable for trap deployment. In the illustrated embodiment, a drawstring 604, also referred to as a purse string, can be tightened to draw the ceiling mesh 602 together in the middle thereof. The drawstring 604 can then be pulled around the ceiling frame section 102 and secured, e.g., by a hook, to the ceiling mesh 602, in order to secure the ceiling mesh 602 in a restored configuration for fishing. The drawstring 604 can be released to loosen the middle of the ceiling mesh 602, allowing the ceiling mesh 602 to collapse into the crustacean trap to facilitate nested stacking of multiple traps.

In another variation of the illustrated second complete trap 600, the floor mesh, e.g., floor mesh 404 such as illustrated in FIG. 4, can optionally also be releasable and restorable, e.g., by including a floor mesh drawstring similar to ceiling mesh drawstring 604. Additionally, the floor frame section 104 introduced in FIG. 1 can optionally include a lid similar to ceiling lid 150, and the lid in the floor frame section 104 can be in addition to the ceiling lid 150, or instead of the ceiling lid 150. By fitting the floor frame section 104 with a drawstring, a lid, or both a drawstring and a lid, the second complete trap 600 can optionally be flipped over to fish in an upside-down orientation. Embodiments can optionally be configured to fish exclusively right-side-up, e.g., as illustrated in FIG. 6, exclusively upside-down, or in both right-side-up and upside-down orientations, allowing fishermen to select a desired orientation based on conditions. The weight bar 140 can optionally be removed or the illustrated embodiment can be modified to support embodiments that are configured to fish upside-down or both right-side-up and upside-down.

FIG. 6 furthermore illustrates a lid securing device 606 to secure the lid 150 in a closed position. In the illustrated embodiment, the lid securing device 606 comprises an elastic band attached to the ceiling frame section 102 and fitted with a hook, wherein the elastic band extends over the lid 150 and the hook attaches to the ceiling mesh 602 to secure the lid 150 in a closed position. In the illustrated embodiment, the lid securing device 606 comprises two leg members which attach to the lid 150, and a third leg member which attaches to the two leg members and includes the hook to attach to the ceiling mesh 602. The illustrated elastic band can be replaced by numerous other means to hold the lid 150 closed, as will be appreciated. A lid securing device 606 can comprise, e.g., a rubber band or rubber inner tube, or a stainless steel, coated steel, or plastic hook or clip, or a twine made of cotton, nylon, poly, or spectra.

With regard to meshes for use with the traps disclosed herein, the meshes may be made of any suitable material, e.g., a poly, nylon, spectra, PVC coated wire, stainless steel, or other web material. While ceiling meshes and entrance meshes are preferably made of flexible materials to allow for nested stacking, floor meshes and side meshes can optionally be rigid. Some portion of the mesh on a trap, e.g., a portion of the ceiling or side mesh, may comprise a cotton panel designed to eventually dissolve in seawater to allow escape from the traps, in the event that a trap is lost or otherwise left on the sea floor.

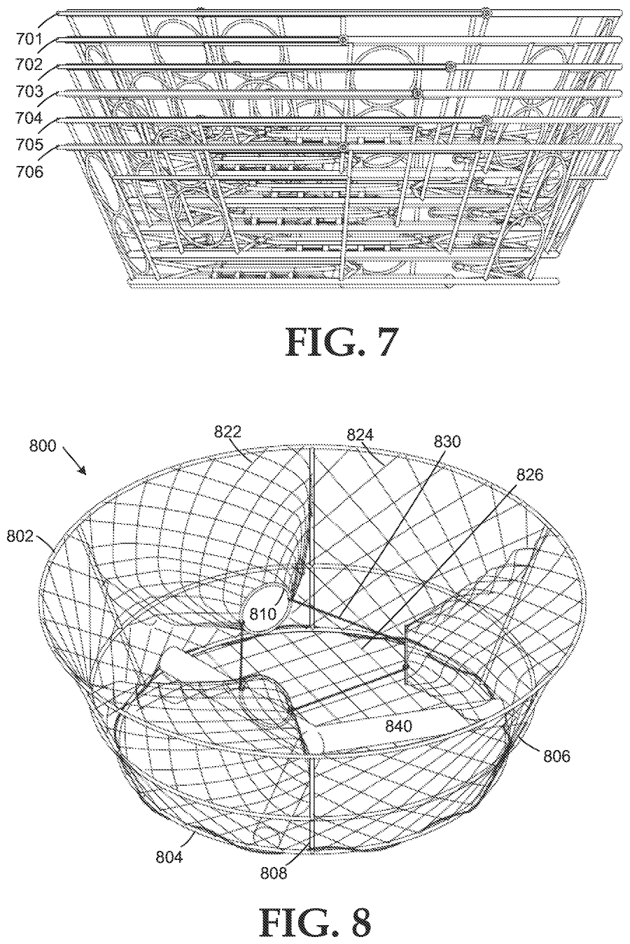

FIG. 7 illustrates nested stacking of multiple traps, in accordance with various aspects and embodiments of the subject disclosure. FIG. 7 includes multiple traps 701, 702, 703, 704, 705, and 706. Trap 701 is nested inside trap 702, trap 702 is nested inside trap 703, trap 703 is nested inside trap 704, and so on. As will be appreciated, the tapered sides of traps 701, 702, 703, 704, 705, and 706 allow the traps to stack in the illustrated nested fashion. Nested stacking increases the number of traps that can be carried on a fishing boat, thereby improving efficiency of fishing operations. The mesh portions of the traps 701, 702, 703, 704, 705, and 706 are not included in FIG. 7 for clarity of illustration. While FIG. 7 uses the traps of FIGS. 1-6 as an example, the prawn and shrimp traps of FIGS. 8-10 allow for nested stacking in similar fashion.

FIG. 8 illustrates an example prawn and shrimp trap, as an example of a trap in accordance with various aspects and embodiments of the subject disclosure. The elements of the prawn and shrimp trap 800 are generally similar to those of the trap illustrated in FIGS. 1-6, and similar materials and design considerations can be used. The ceiling mesh is omitted from prawn and shrimp trap 800 in FIG. 8 in order to more clearly depict the other elements thereof.

Similar to the trap illustrated in FIGS. 1-6, the prawn and shrimp trap 800 comprises a trap frame comprising: a floor frame section 804 defining a floor surface area, and a ceiling frame section 802 defining a ceiling surface area, wherein the ceiling surface area is larger than the floor surface area. The illustrated floor frame section 804 and ceiling frame section 802 are circular, however, other shapes such as rectangles and polygons can be used in other embodiments. A plurality of angled struts 806 connect the floor frame section 804 to the ceiling frame section 802 and define a tapered side between the floor frame section 804 and the ceiling frame section 802.

The trap frame for prawn and shrimp trap 800 further includes a middle frame section 806, positioned between the floor frame section 804 and the ceiling frame section 802, and defining a middle surface area between the floor surface area and the ceiling surface area. In the illustrated embodiment, middle frame section 806 is positioned below the midpoint between the floor frame section 804 and the ceiling frame section 802.

The prawn and shrimp trap 800 can comprise a weight bar 840, a floor mesh 826 extending over the floor surface area, and a side mesh 824 extending over portions of the tapered side, similar to the trap illustrated in FIGS. 1-6. However, in the illustrated embodiment, below the middle frame section 806 the side mesh 824 extends completely around the tapered side of the prawn and shrimp trap 800, because the entrances are in portions of the tapered side that are above the middle frame section 806.

Entrance meshes 822 extend inwardly from respective portions of the trap frame to respective entrance frames 810. Entrance meshes 822 are wider at the tapered side, and become narrower as they extend to entrance frames 810. The entrance frames 810 are attached to the entrance meshes 822 and form entrances into the crustacean trap 800. Unlike the crab trap design illustrated in FIGS. 1-6, the entrance frames 810 for the prawn and shrimp trap 800 are free floating by remaining unattached to any rigid support struts. Tensioning elements 830 can pull the entrance frames 810 inwardly, countered by tension from the entrance meshes 822, to hold the entrance frames 810 in their fishing positions. Tensioning elements 830 can be releasable, e.g., by hooking or otherwise releasably fastening to entrance frames 810, to allow the entrance frames 810 to collapse by releasing tension on the entrance meshes 822, to facilitate nested stacking of multiple crustacean traps.

While the prawn and shrimp trap 800 illustrated in FIG. 8 comprises three entrance meshes 822, it will be appreciated that larger and smaller embodiments can be made. For example, versions with six, nine, twelve, or another number of entrances can be made according to the principles disclosed herein.

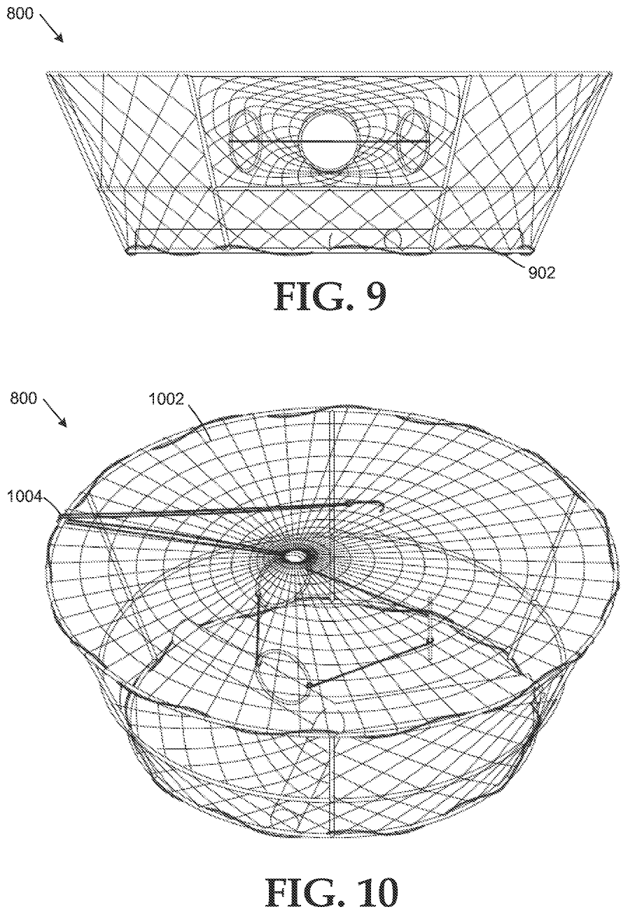

FIG. 9 illustrates an elevation view of the example prawn and shrimp trap introduced in FIG. 8, in accordance with various aspects and embodiments of the subject disclosure. Repetitive description of like elements is omitted for the sake of brevity. FIG. 9 illustrates a sewing line 902 to sew mesh onto the trap frame. In general, the meshes disclosed herein can be tied, sewn, or otherwise attached to the trap frame.

FIG. 10 illustrates the example prawn and shrimp trap introduced in FIG. 8, and further comprising a collapsible ceiling mesh, in accordance with various aspects and embodiments of the subject disclosure. Repetitive description of like elements is omitted for the sake of brevity. In FIG. 10, a ceiling mesh 1002 extends over the ceiling surface area of the prawn and shrimp trap 800. The ceiling mesh 1002 is releasable to allow nested stacking of multiple traps, and the ceiling mesh 1002 is restorable for trap deployment.

In the illustrated embodiment, a drawstring 1004, similar to the drawstring 604 illustrated in FIG. 6, can be tightened to draw the ceiling mesh 1002 together in the middle thereof. The drawstring 1004 can then be pulled around the ceiling frame section 802 and secured, e.g., by a hook, to the ceiling mesh 1002, in order to secure the ceiling mesh 1002 in a restored configuration for fishing. The drawstring 1004 can be released to loosen the middle of the ceiling mesh 1002, allowing the ceiling mesh 1002 to collapse into the trap to facilitate nested stacking of multiple traps.

FIG. 11 illustrates an example self-erecting entrance frame, as well as a wide aspect ratio entrance frame, in accordance with various aspects and embodiments of the subject disclosure. In some embodiments, entrance frames such as illustrated in FIG. 11 can be incorporated into traps such as illustrated in FIGS. 1-6.

FIG. 11 includes an entrance frame 1108 analogous to the entrance frame 108 introduced in FIG. 1, a support strut crossbar element 1116 analogous to the crossbar of support strut 116 introduced in FIG. 1, and entrance frame hinge elements 1110 analogous to the entrance frame hinge elements 110 introduced in FIG. 1. In addition, FIG. 11 includes biasing mechanisms in the form of coils 1150, which may also be described as torsion springs, wrapped around the support strut crossbar element 1116, the coils 1150 each comprising a leg which can extend up a side of the entrance frame 1108 to an attachment point 1151. The attachment point 1151 can comprise a weld or other means of affixing the coil leg on the entrance frame 1108.

The coils 1150 can bias the entrance frame 1108 in an upward/forward direction. The entrance frame 1108 can be pushed back/down into a horizontal orientation, e.g., by hand or by the weight of another trap stacked on top of the entrance frame 1108. However, when released, the coils 1150 can return the entrance frame 1108 to the upward/forward orientation. When an upper mesh, e.g., upper mesh 302 (illustrated in FIG. 1) is in place, the coils 1150 can pull the upper mesh 302 tight and the upper mesh 302 can “pull back” on the entrance frame 1108 to hold the entrance frame 1108 in the vertical orientation.

In an aspect, the entrance frame 1108 can optionally be fitted with one or more one-way gates, such as the one-way gates 112 illustrated in FIG. 1. Alternatively, in some embodiments, an obstructing mesh can partially obstruct the opening of the entrance frame 1108. For example, an upper mesh 302 can extend over the top of the entrance frame 1108 and extend downward to form an obstructing mesh curtain over the entrance frame 1108. The obstructing mesh can optionally also be attached along at least portions of the sides of the entrance frame 1108, in order to better obstruct exit from the trap. In still further embodiments, which may be appropriate for some applications, the entrance frame 1108 can remain unobstructed.

The entrance frame 1108 is a wide aspect ratio entrance frame. A wide aspect ratio entrance frame, as defined herein, is an entrance frame with a width to height aspect ratio equal or greater to 3:1. The width dimension illustrated in FIG. 11 can be three or more times larger than the height dimension illustrated in FIG. 11. In some embodiments, wide aspect ratio entrance frames according to this disclosure can comprise entrance frames with a width to height aspect ratio equal or greater to 4:1. In some embodiments, wide aspect ratio entrance frames according to this disclosure can comprise entrance frames with a width to height aspect ratio equal or greater to 5:1. In some embodiments, wide aspect ratio entrance frames according to this disclosure can comprise entrance frames with a width to height aspect ratio equal or greater to 6:1. Wide aspect ratio entrance frames are particularly useful for catching flat fish. A variety of flat fish species exist and are of different sizes. Therefore the overall size of the illustrated entrance frame 1108 can range from small, e.g., about one foot wide, to quite large, e.g., about three or more feet wide.

FIG. 12 and FIG. 13 illustrate another example self-erecting entrance frame in accordance with various aspects and embodiments of the subject disclosure. FIG. 12 provides a front elevation view of the example self-erecting entrance frame 1208, and FIG. 13 provides a side elevation view of the example self-erecting entrance frame 1208. The illustrated entrance frame 1208 can be a wide aspect ratio entrance frame, similar in dimensions to the entrance frame 1108 illustrated in FIG. 11.

FIG. 12 and FIG. 13 include entrance frame 1208, analogous to the entrance frame 108 introduced in FIG. 1, a support strut crossbar element 1216 analogous to the crossbar of support strut 116 introduced in FIG. 1, entrance frame hinge elements 1210 analogous to the entrance frame hinge elements 110 introduced in FIG. 1, and an upper mesh 1202 analogous to the upper mesh 302 introduced in FIG. 3. In addition, FIG. 12 and FIG. 13 include an example frame lever 1275 that extends from the entrance frame hinge elements 1210, a floor frame section 1204 analogous to the floor frame section 104 introduced in FIG. 1, and biasing mechanisms in the form of elastic bands 1250 attached between the frame lever 1275 and the floor frame section 1204. Example attachment points 1251 indicate attachments between the elastic bands 1250, the frame lever 1275, and the floor frame section 1204. The elastic bands 1250 can be tied or otherwise fastened at the attachment points 1251.

The elastic bands 1250 can pull the frame lever 1275 to bias the entrance frame 1208 in an upward/forward direction. The entrance frame 1208 can be pushed back/down into a horizontal orientation, e.g., by hand or by the weight of another trap stacked on top of the entrance frame 1208. However, when released, the elastic bands 1250 can return the entrance frame 1208 to the upward/forward orientation. The elastic bands 1250 can pull the upper mesh 1202 tight and the upper mesh 1202 can “pull back” on the entrance frame 1208 to hold the entrance frame 1208 in the vertical orientation.

In some embodiments, the frame lever 1275 can form an angle θ with the entrance frame 1208, as illustrated in FIG. 13. The angle θ can be between 90 and 180 degrees, e.g., 165 degrees. Furthermore, it will be appreciated that the elastic bands 1250 can attach anywhere in a radially outward direction from the frame lever 1275, and the elastic bands 1250 need not necessarily attach to the floor frame section 1204 as shown in FIG. 12. In an aspect, the entrance frame 1208 can optionally be fitted with one or more one-way gates, or with an obstructing mesh, or the entrance frame 1208 can remain unobstructed, as discussed above with reference to entrance frame 1108.

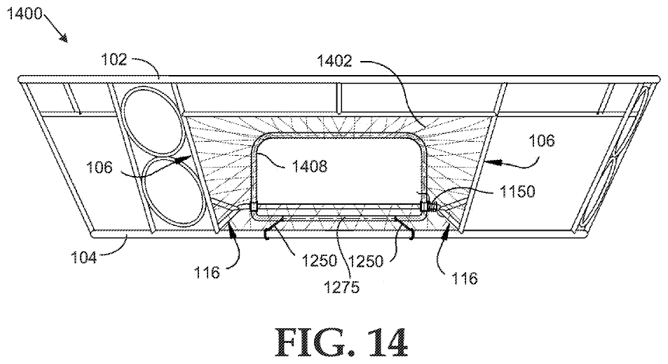

FIG. 14 provides a side elevation view of an aquatic trap frame 1400 comprising a self-erecting entrance frame that uses the biasing mechanisms introduced in FIG. 11 and FIG. 12, in accordance with various aspects and embodiments of the subject disclosure. FIG. 14 includes a ceiling frame section 102, a floor frame section 104, angled struts 106, support struts 116, and a meshed entrance into the trap, which can be understood by reference to FIGS. 1-6. The meshed entrance includes a self-erecting entrance frame 1408, with entrance meshes installed, e.g., including ceiling mesh 1402.

FIG. 14 demonstrates the use of two different biasing mechanisms in connection with self-erecting entrance frame 1408. FIG. 14 includes a coil 1150 such as introduced in FIG. 11, and a frame lever 1275 with elastic bands 1250 such as introduced in FIGS. 12 and 13. While some embodiments can include two or more different biasing mechanisms as shown, other embodiments may include one biasing mechanism and omit the other biasing mechanism.

FIG. 15 provides a top view of an aquatic trap frame 1500 comprising a weight adjustment system, in accordance with various aspects and embodiments of the subject disclosure. The illustrated aquatic trap frame 1500 can include elements of any of the trap frames disclosed herein, e.g., elements of trap frame 100 such as illustrated in FIG. 1. For example, the aquatic trap frame 1500 can include a lid 150, a top frame section 102, a bottom frame section 104, angled struts 106 that define a tapered side wall, and entrances. An example entrance is illustrated in FIG. 15.

The aquatic trap frame 1500 can furthermore be fitted with a weight bar 1540, analogous to the weight bar 140 introduced in FIG. 1. However, in FIG. 15, the weight bar 1540 can optionally be lighter weight than the weight bar 140, e.g., by making the weight bar 1540 from a same or similar material and gauge as other elements of the aquatic trap frame 1500, such as the material used for top frame section 102 and bottom frame section 104. Instead of being a fixed weight, the weight bar 1540 can be a part of a weight adjustment system that includes distributed weight attachment points 1541 and weights 1542. The weight adjustment system comprising weight bar 1540, weight attachment points 1541, and weights 1542 can allow custom, reconfigurable weighting of the aquatic trap frame 1500.

The weight attachment points 1541 can comprise threaded posts, threaded holes, or other structures to attach and remove weights 1542. FIG. 15 illustrates one weight attachment point 1541, understanding that additional weight attachment points 1541 are disposed under each of the weights 1542. The weight attachment points 1541 can be distributed symmetrically around the perimeter of the aquatic trap frame 1500. For example, weight attachment points 1541 can be positioned at an end of each member of the weight bar 1540, at a same distance from the bottom frame section 104, as shown. Further weight attachment points 1541 can be optionally be positioned in balanced, symmetrical fashion, on the weight bar 1540 or elsewhere on the aquatic trap frame 1500. For example, a weight attachment point 1541 can be positioned in the center of the weight bar 1540, as shown by the presence of a weight 1542 at that location. In addition to the weight attachment points 1541, the weight bar 1540 can include an attachment point 1543 for an anode such as anode 142, illustrated in FIG. 1.

In an embodiment, the weight bar 1540 can be constructed of the same material as the rest of the aquatic trap frame 1500, e.g., stainless steel, or optionally, composite material, optionally manufactured through a 3D printing process. Threaded nuts, e.g., half inch hex nuts, can be welded to the weight bar 1540 to serve as attachment points 1541. Weights 1542 can be configured to removably attach to weight attachment points 1541, e.g., weights 1542 can comprise threaded posts that screw into the threaded nuts. Weights 1542 can optionally be made of rubber-dipped metal, and can comprise, e.g., four inch diameter disks weighing about seven pounds. Alternatively, weights 1542 can be made of any suitable material, and can be of any size, shape, and weight as may be desired for particular embodiments. A variety of different weights 1542 can optionally be employed for different fishing conditions. Weights 1542 weighing about three pounds to about twenty pounds each should be suitable for most trap sizes and fishing conditions.

While the illustrated attachment points 1541 are on the weight bar 1540, it will be appreciated that embodiments may vary by placing the attachment points 1541 in other locations, e.g., distributed around the floor section 104 of the aquatic trap frame 1500. In such embodiments, the weight bar 1540 can optionally be eliminated from the aquatic trap frame 1500.

The embodiments illustrated herein are examples only, and numerous variations are possible as will be appreciated. Variations in size, shape, and weight may be made. Example dimensions may be, e.g., two to six feet in diameter. Example shapes may be circular as shown herein, or oval, square, rectangular or triangular. Example weights may be six to one hundred twenty (120) pounds, most of which is determined by dimensions and frame sizing. Frame joints may be welded or cast, or held together with bolts or other fasteners. The number of entrance frames may vary, e.g., from one to twelve entrance frames.

To manufacture the disclosed crustacean traps, steps may generally include the following. While these steps may be performed in the described sequence, the sequence can also be modified as will be appreciated. Also, some of the steps may be omitted in connection with manufacturing some embodiments, e.g., fewer steps may be needed to manufacture the simpler prawn and shrimp embodiments disclosed herein.

The frame can be constructed of steel, composite, or other material as disclosed herein. Floor and ceiling frame sections can be made in their different sizes and welded together with angled struts to form a conical shape. The weight bar can then be added to the frame. The weight bar may be “Y” shaped or for example a double cross bar ranging in weight, length and thickness of steel (or other material) from one to one hundred twenty (120) pounds depending on the application (lighter for sport applications or heavier for ocean commercial applications). The escape rings may then be attached, typically no less than two and up to six escape rings, for faster release of small crabs and made from the same materials as the frame.

The entrance frames can be constructed of the same materials as the frame. Construction can comprise bending or shaping stainless steel or other materials, and attaching entrance frames with hinges such as swivel joints to allow rotation of the entrance frames. In some embodiments, entrance frames can be made of composite material through a 3D printing process. Once the entrance frames are made and optionally attached, the upper and lower entrance meshes can be attached. Side mesh can then be installed, including tapered panels between entrances and escape rings. Panels of webbing may be sewn or attached. The floor mesh may then be attached, by sewing or attaching mesh to the floor frame section.

In embodiments comprising one-way gate members, the one-way gate members can be installed by fitting them on the entrance frames. One-way gate members may be single or double and made of stainless or coated steel.

The lid can be attached to the frame. The lid can be fitted and the lid hinges can be welded to the ceiling frame section so that the lid can open manually by the operator of the trap. The lid can be closed and secured in its operating position with the lid securing device 606.

The collapsing ceiling mesh can be attached to the trap by sewing or attaching half to ceiling frame section, and half to the lid. The collapsing ceiling mesh can be drawn closed by a purse string closure in the center of the top most portion of the trap. An elastic material such as bungee cord, rubber inner tube or rubber band and a plastic, stainless or coated steel hook or snap may be used on the end of the purse string to secure the collapsing ceiling mesh in the closed (restored) position during operation or unsecured/relaxed position for nesting the traps.

Finally, a dissolving panel of cotton or other material can be attached as a mesh section of the trap.

Methods of using the disclosed traps will be readily apparent to those of skill in the art. In general, methods may include releasing the ceiling mesh drawstring and the entrance frame tensioning element to collapse the ceiling mesh and entrance frames. The traps can then be stacked in a nested fashion. When restoring the traps for deployment, the traps can be unstacked and the ceiling mesh can be restored to its tightened position by pulling the drawstring tight and fastening the drawstring in a closed position. The lid may be opened, and the tensioning element(s) can be restored to restore the entrance frames in their fishing positions. Bait may be attached inside the traps, e.g., to the tensioning elements. The lid may be closed and fastened shut using the lid securing device. With a line and buoy attached to the trap, the trap is now ready to fish. The trap may be dropped overboard and the weight bar and tapered sides will guarantee that the trap lands on the sea floor in the correct upright position.

While various embodiments have been disclosed herein, other aspects and embodiments will be apparent to those skilled in art.

1. A crustacean trap, comprising:
a trap frame, comprising:
a floor frame section defining a floor surface area;
a weight bar attached to the floor frame section;
a ceiling frame section defining a ceiling surface area, wherein said ceiling surface area is larger than said floor surface area; and
a plurality of angled struts connecting the floor frame section to the ceiling frame section and defining a tapered side between the floor frame section and the ceiling frame section;
a floor mesh extending over the floor surface area;
a side mesh extending over a first portion of the tapered side;
an entrance mesh extending inwardly from a second portion of the tapered side;
an entrance frame attached to the entrance mesh and forming an entrance into the crustacean trap;
a tensioning element to pull the entrance frame inwardly; and
a ceiling mesh extending over the ceiling surface area, wherein the ceiling mesh is releasable to allow nested stacking of multiple crustacean traps, and wherein the ceiling mesh is restorable for crustacean trap deployment.

2. The crustacean trap of claim 1, wherein the ceiling mesh comprises a web of flexible cord and a drawstring, wherein the drawstring is releasable in order to release the ceiling mesh, and wherein the drawstring is tensioned in order to restore the ceiling mesh.

3. The crustacean trap of claim 1, wherein the ceiling frame section includes a lid, and wherein the lid is openable and closable to access an interior of the aquatic trap without releasing the ceiling mesh.

4. The crustacean trap of claim 1, wherein the entrance frame is attached by an entrance frame hinge element to a support strut, and wherein the tensioning element is releasable to allow the entrance frame to collapse by rotating on the entrance frame hinge element, to facilitate nested stacking of multiple crustacean traps.

5. The crustacean trap of claim 1, further comprising a one-way gate attached by a gate hinge to the entrance frame.

6. The crustacean trap of claim 1, wherein the entrance frame is free floating by remaining unattached to any rigid support strut, and wherein the tensioning element is releasable to allow the entrance frame to collapse by releasing tension on the entrance mesh, to facilitate nested stacking of multiple crustacean traps.

7. The crustacean trap of claim 1, wherein the entrance mesh comprises an upper mesh having relatively larger mesh openings, and a lower mesh having relatively smaller mesh openings.

8. The crustacean trap of claim 1, further comprising a threaded post affixed to the weight bar, wherein an anode can be screwed onto the threaded post.

9. The crustacean trap of claim 1, wherein the weight bar is configured in a “Y” shape consisting of three members joined at a middle of the floor surface area.

10. The crustacean trap of claim 1, wherein the floor frame section and the ceiling frame section are circular in shape.

11. The crustacean trap of claim 1, wherein the plurality of angled struts connecting the floor frame section to the ceiling frame section are at ten to twenty degree angles from directions normal to the floor surface area and ceiling surface area.

12. The crustacean trap of claim 1, further comprising multiple entrance frames attached to multiple entrance meshes and forming multiple entrances into the crustacean trap, and wherein the tensioning element extends between the multiple entrance frames.

13. The crustacean trap of claim 1, wherein the trap frame further comprises one or more of an escape ring or an escape window.

14. An aquatic trap, comprising:
a trap frame, comprising:
a floor frame section defining a floor surface area;
a ceiling frame section defining a ceiling surface area, wherein said ceiling surface area is larger than said floor surface area; and
a plurality of angled struts connecting the floor frame section to the ceiling frame section and defining a tapered side between the floor frame section and the ceiling frame section;
a floor mesh extending over the floor surface area;
a side mesh extending over a first portion of the tapered side;
an entrance mesh extending inwardly from a second portion of the tapered side;
a collapsible entrance frame attached to the entrance mesh and forming an entrance into the aquatic trap;
a biasing mechanism to bias the entrance frame in a vertical orientation; and
a ceiling mesh extending over the ceiling surface area, wherein the ceiling mesh is releasable to allow nested stacking of multiple aquatic traps, and wherein the ceiling mesh is restorable for aquatic trap deployment.

15. The aquatic trap of claim 14, wherein the biasing mechanism comprises a coil.

16. The aquatic trap of claim 14, wherein the biasing mechanism comprises an elastic element.

17. The aquatic trap of claim 16, wherein the elastic element extends between a frame lever affixed between the entrance frame and a perimeter of the aquatic trap.

18. The aquatic trap of claim 14, wherein the entrance frame is a wide aspect ratio entrance frame.

19. An aquatic trap, comprising:
a trap frame, comprising:
a floor frame section defining a floor surface area;
a ceiling frame section defining a ceiling surface area, wherein said ceiling surface area is larger than said floor surface area; and
a plurality of angled struts connecting the floor frame section to the ceiling frame section and defining a tapered side between the floor frame section and the ceiling frame section;
a floor mesh extending over the floor surface area;
a side mesh extending over a first portion of the tapered side;
an entrance mesh extending inwardly from a second portion of the tapered side;
a collapsible entrance frame attached to the entrance mesh and forming an entrance into the aquatic trap;
an adjustable weighting system, the adjustable weighting system comprising multiple weight attachment points on the aquatic trap; and
a ceiling mesh extending over the ceiling surface area, wherein the ceiling mesh is releasable to allow nested stacking of multiple aquatic traps, and wherein the ceiling mesh is restorable for aquatic trap deployment.

20. The aquatic trap of claim 19, wherein at least some of the multiple weight attachment points are distributed symmetrically about a perimeter of the aquatic trap.

21. The aquatic trap of claim 19, further comprising a weight bar attached to the floor frame section, and wherein the multiple weight attachment points are on the weight bar.
